(19) United States
(12) Patent Application Publication
(10) Pub. No.: US 2011/0089622 A1
(43) Pub. Date: Apr. 21, 2011

(54) Cutting Board

(76) Inventor: Sunghee Ji, Mitaka-shi (JP)

(21) Appl. No.: 12/806,355

(22) Filed: Aug. 10, 2010

(30) Foreign Application Priority Data
Aug. 11, 2009 (JP) 2009-186275
Jun. 24, 2010 (JP) 2010-144229

(51) Int. Cl. A47J 47/00

(52) U.S. Cl. 269/289 R

(57) ABSTRACT

A cutting board includes a main body provided with a first plane and a second plane of N-gon shape (N is an integer not less than 4), the first plane and the second plane being mutually disposed at front and back.

The main body includes:
a first wall projecting towards the first plane side from at least a part of a first side connecting a first vertex and a second vertex disposed adjacently of the main body;
a second wall projecting towards the first plane side from at least a part of a second side extending from the first vertex in a direction which is different from the second vertex;
a third wall projecting towards the second plane side from at least a part of a third side, the third side connecting a third vertex that is farthest from the first vertex to a fourth vertex that is farthest from the second vertex; and
a fourth wall projecting towards the second plane side from at least a part of a fourth side extending from the third vertex in a direction which is different from the fourth vertex.
A projection height of the first wall is gradually reduced from the first vertex side towards the second vertex side,
a projection height of the second wall at the first vertex side is approximately identical to the projection height of the first wall at the first vertex side, and is maximized,
a projection height of the third wall is gradually reduced from the third vertex side towards the fourth vertex side, and
a projection height of the fourth wall at the third vertex side is approximately identical to the projection height of the third wall at the third vertex side, and is maximized.

This application claims priority under 35 U.S.C. §119 from Japanese patent application Serial No. 2009-186275, filed Aug. 11, 2009, entitled “Shoelace, band for bag, positioning device, cutting board and sheet body cutting device” and Japanese patent application Serial No. 2010-144229, filed Jun. 24, 2010, entitled “Cutting board,” which are incorporated herein by reference in their entirety.

### TECHNICAL FIELD

The present invention relates to a cutting board.

### BACKGROUND OF THE INVENTION

When preparing foods on a normal flat cutting board, while the food material adhering to a knife peals off, sometimes it tumbles down from the preparing surface. When preparing liquid state materials, the food material may sometimes spill from the preparing surface onto the periphery of the cutting board. A cutting board is proposed where it is possible to prevent such type of spillage of food materials cut by a knife, and to simplify the operation of transferring directly to a pan, etc. (for example, see Patent document 1.).

[Prior Art Documents]

[Patent Documents]

[Patent document 1] Japanese Utility model registration No. 3134737

However, in the above-mentioned conventional cutting boards, when cooking liquid state food materials, even if the food material flows on the preparing surface and bumps into a convex section, the food material may nevertheless spill out from both sides of the convex section. On the other hand, if a convex section is provided so as to surround the periphery of the preparing surface, the convex section can become an obstacle and transferring directly from the sides of the cooking surface to a pan, etc., becomes difficult.

The present invention was made in view of the above circumstances, and intends to provide a cutting board in which the directions of scatter, rolling or flow on the cutting board can be maneuvered in the same direction, and the food material can be also transferred easily out of the cutting board.

### SUMMARY OF THE INVENTION

The present invention adopts following means to solve the above-mentioned problems.

A cutting board of the present invention includes a main body provided with a first plane and a second plane of N-gon shape (N is an integer not less than 4), the first plane and the second plane being mutually disposed at front and back, and the main body includes:
a first wall projecting towards the first plane side from at least a part of a first side connecting a first vertex and a second vertex disposed adjacently of the main body;
a second wall projecting towards the first plane side from at least a part of a second side extending from the first vertex in a direction which is different from the second vertex;
a third wall projecting towards the second plane side from at least a part of a third side, the third side connecting a third vertex that is farthest from the first vertex to a fourth vertex that is farthest from the second vertex; and
a fourth wall projecting towards the second plane side from at least a part of a fourth side extending from the third vertex in a direction which is different from the fourth vertex, wherein,
a projection height of the first wall is reduced from the first vertex side towards the second vertex side,
a projection height of the second wall at the first vertex side is approximately identical to the projection height of the first wall at the first vertex side, and is maximized,
a projection height of the third wall is reduced from the third vertex side towards the fourth vertex side, and
a projection height of the fourth wall at the third vertex side is approximately identical to the projection height of the third wall at the third vertex side, and is maximized.

In this invention, when kept on a horizontal plane such that the first plane becomes the front side, the main body can be kept in an inclined position supported by the first vertex on the second plane, the third wall and the fourth wall, such that the third vertex side is located at the highest point from the horizontal plane, and the first vertex side is at the lowest point. Therefore, a food material or a liquid state material prepared on the first plane can be moved from the third vertex side towards the first vertex side by gravity. During this, the tumbling down of the food material on the first plane or the flowing of the liquid state material from the first plane can be prevented by the first wall and the second wall. On the other hand, the food material can be easily transferred out of the main body from a spot where the first wall and the second wall are absent. Thereupon, a slender and long food material can be placed on the first plane avoiding contact with the first wall and the second wall. Here, as the second plane is floating from the horizontal plane, to prepare a food material that is different from that of the first plane, the front and back sides are changed such that the second plane becomes the preparing surface of the front side and the food material can be immediately placed on the second plane for preparation. During this, using the third vertex on the first plane, the first wall and the second wall as supports, the main body can be inclined such that the first vertex side is located at the highest point from the horizontal plane while the third vertex point side is located at the lowest point. In addition, after preparation of foods, it can be made self-standing by setting the first wall or the second wall as bottom.

Further, the cutting board of the present invention is the cutting board mentioned above, wherein the first plane and the second plane are of rectangular shapes,

the projection height of the second wall gradually decreases in a proportion substantially the same as that of the first wall, and

the projection height of the fourth wall gradually decreases in a proportion substantially the same as that of the third wall.

In this invention, foods can be prepared with the main body disposed in a more stable position.

Further, the cutting board of the present invention is the cutting board mentioned above, wherein the first plane and the second plane have not less than 5 sides,

the projection height of the second wall is approximately the same as a maximum projection height of the first wall, and is approximately constant, or

the projection height of the fourth wall is approximately the same as a maximum projection height of the third wall and is approximately constant.

In this invention, when the first plane is made as the front side, the food material or the liquid state material prepared on the first plane can be preferably moved from the third vertex side by gravity to the second side of the main body. When the second plane is made as the front side, the food material or the liquid state material prepared on the second plane can be preferably moved from the first vertex side by gravity to the fourth side of the main body.

Further, the cutting board of the present invention is the cutting board mentioned above, wherein

the first wall and the second wall are joined at the first vertex, and

the third wall and the fourth wall are joined at the third vertex.

In this invention, preparing a liquid state material using the first plane as the front side, the liquid state material flowing towards the first vertex can be preferably prevented from running out of the first plane. In this invention, preparing a liquid state material using the second plane as the front side, the liquid state material flowing towards the third vertex can be preferably prevented from running out of the second plane.

According to the present invention, while it becomes possible to maneuver the scattering, tumbling or flow of the food material in the same direction, the food material can also be easily transferred out of the cutting board.

### BRIEF DESCRIPTION OF THE DRAWINGS

FIG. 1 is (a) a perspective view and (b) a perspective view from a direction different from (a), both views being of the cutting board of the first embodiment of the present invention.

FIG. 2 is (a) a plane view and (b) the cross sectional view of X1-X1 in (a), both views being of the cutting board of the first embodiment of the present invention.

FIG. 3 is a perspective view of the cutting board of the second embodiment of the present invention.

FIG. 4 is a plane view of the cutting board of the second embodiment of the present invention.

### DETAILED DESCRIPTION OF INVENTION

### First Embodiment

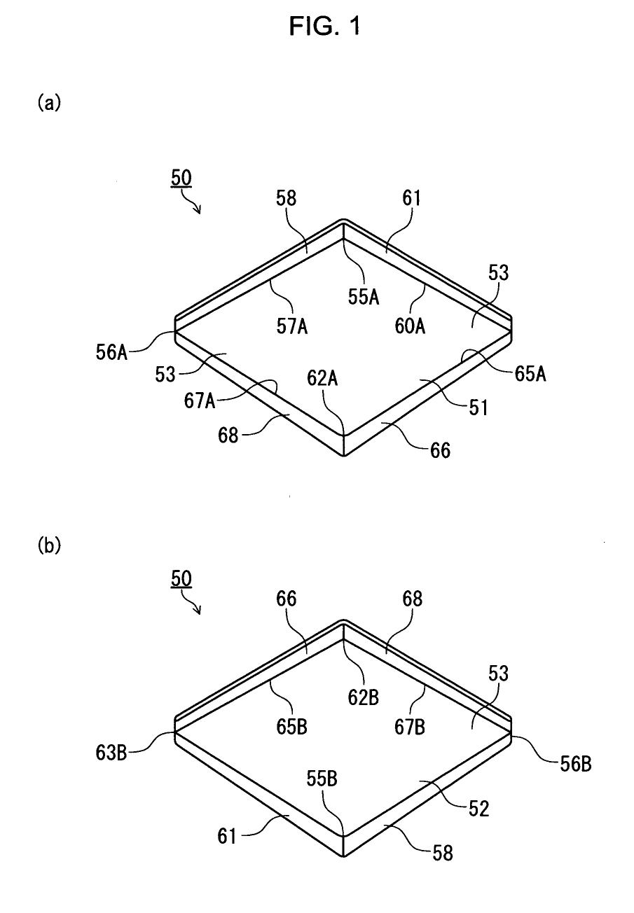

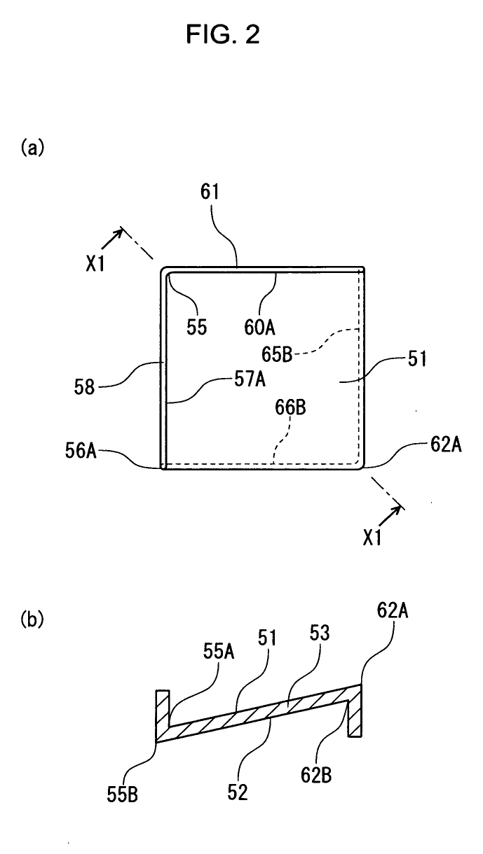

The first embodiment of the present invention is explained with reference to FIG. 1 and FIG. 2.

A cutting board 50 of the first embodiment of the present invention includes a main body 53 provided with a first plane 51 and a second plane 52 of quadrangular shape that are mutually disposed at front and back, and the main body 53 includes a first wall 58 projecting towards the first plane 51 side from a first side 57A, the first side 57A connecting a first vertex 55A and a second vertex 56A disposed adjacently on the first plane 51 of the main body 53, a second wall 61 projecting towards the first plane 51 side from a second side 60A on the first plane 51, the second side 60A extending from the first vertex 55A in a direction which is different from the second vertex 56A, a third wall 66 projecting towards the second plane 52 side from a third side 65B, the third side 65B connecting a third vertex 62B that is farthest from a first vertex 55B to a fourth vertex 63B that is farthest from the second vertex 56B provided on the second plane 52, and a fourth wall 68 projecting towards the second plane 52 side from a fourth side 67B on the second plane 52, the fourth side 67B extending from the third vertex 62B in a direction which is different from the fourth vertex 63B on the second plane 52.

The first wall 58 is formed such that it has a maximum projection height at the first vertex 55A side and the projection height gradually decreases towards the second vertex 56A side. The second wall 61 is joined to the first wall 58 at the first vertex 55A. Further, it is formed such that a projection height of the second wall 61 at the first vertex 55A side is approximately identical to the projection height of the first wall 58 at the first vertex 55A and is maximized, and gradually decreases in a proportion substantially the same as that of the first wall 58. In this, the projection heights of the first wall 58 and the second wall 61 are adjusted such that at least part of each apex of the first wall 58 and the second wall 61 and the third vertex 62A are provided on the same plane.

The third wall 66 is formed such that it has a maximum projection height at the third vertex 62B side and the projection height gradually decreases towards the fourth vertex 63B side. The fourth wall 68 is joined to the third wall 66 at the third vertex 62B. Further, it is formed such that a projection height of the fourth wall 68 at the third vertex 62B side is approximately identical to the projection height of the third wall 66 at the third vertex 62B and is maximized, and gradually decreases in a proportion substantially the same as that of the third wall 66. In this, the projection heights of the third wall 66 and the fourth wall 68 are adjusted such that at least part of each apex of the third wall 66 and the fourth wall 68 and the first vertex 55B are provided on the same plane.

Here, the main body 53 and each of the walls 58, 61, 66 and 68 may be fabricated in one body from same material, or each of the walls 58, 61, 66 and 68 may be fabricated separately from a material which is different from the material of the main body 53, for example, whose surface is slip-resistant. Further, each of the walls 58, 61, 66 and 68 around the main body 53 of uniform board thickness may be also disposed such that they can be attached or removed.

Next, operation of the cutting board 50 of this embodiment is explained.

When preparing the food material, the cutting board 50 is placed on a horizontal plane (not shown in the figures) such that the first plane 51 becomes the front side. During this, the main body 53 can be kept in an inclined position supported by the first vertex 55B on the second plane 52, the third wall 66 and the fourth wall 68, such that the third vertex 62A side is at the highest point on the first plane 51 and the first vertex 55A side is at the lowest point. During this, the food material or the liquid state material prepared on the first plane 51 moves by gravity from the third vertex side 62A side to the first vertex side 55A side. Thereupon, by encountering the first wall 58 and the second wall 61, the movement is controlled. During this, since the first wall 58 and the second wall 61 are connected at the first vertex 55A, the food material or the liquid state material is held back, thereby preventing the flow off from the first plane 51.

When transferring a food material out of the main body 53, it can be transferred from a side of the third side 65A or the fourth side 67A on the first plane 51 where the first wall 58 and the second wall 61 are absent.

During this, as the second plane 52 is away from the horizontal plane, to simultaneously prepare a food material that is different from the one prepared on the first plane 51, the front and rear are changed such that the second plane 52 side becomes the preparing surface of the front side and the food material can be placed immediately on the second plane 52 and prepared. During this, the main body 53 is disposed in an inclined position supported by the third vertex 62B on the first plane 51, the first wall 58 and the second wall 61, such that the first vertex side 55B side is located at the highest point on the second plane 52 and the third vertex 62B side is located at the lowest point. During this, since the third wall 66 and the fourth wall 68 are connected at the third vertex 62B, even though the food material is kind of a liquid state material, it is prevented from flowing off from the second plane 52. In addition, after preparation of foods, it can be made self-standing by setting the first wall 58, the second wall 61, third wall 66, or the fourth wall 68 as bottom.

According to this cutting board 50, the main body 53 can be positioned in an inclined position in a given direction, and the direction of scatter, rolling or flow of a food material on the preparing surface can be maneuvered in the same direction. Thereupon, the outflow can be held back by the first wall 58 and the second wall 61, or the third wall 66 and the fourth wall 68. On the other hand, when transferring these food materials out of the cutting board 50, it will be possible to easily transfer from a spot where the first wall 58 and the second wall 61, or the third wall 66 and the fourth wall 68 are absent. In a case of a liquid state material, by collecting the liquid state material near the first vertex 55A or the third vertex 62B, and using this as a spout, the liquid state material can be easily transferred out of the cutting board 50. In addition, the position of the wall can be freely changed according to the hand holding the knife, and it can be used irrespective of right-handedness or left-handedness.

Incidentally, it is sufficient if the first wall 58 projects from at least part of the first side 57A, and the food material tumbling over the first plane 51 can be controlled by the first wall 58. This also applies to the second wall 61, the third wall 66, and the fourth wall 68.

### Second Embodiment

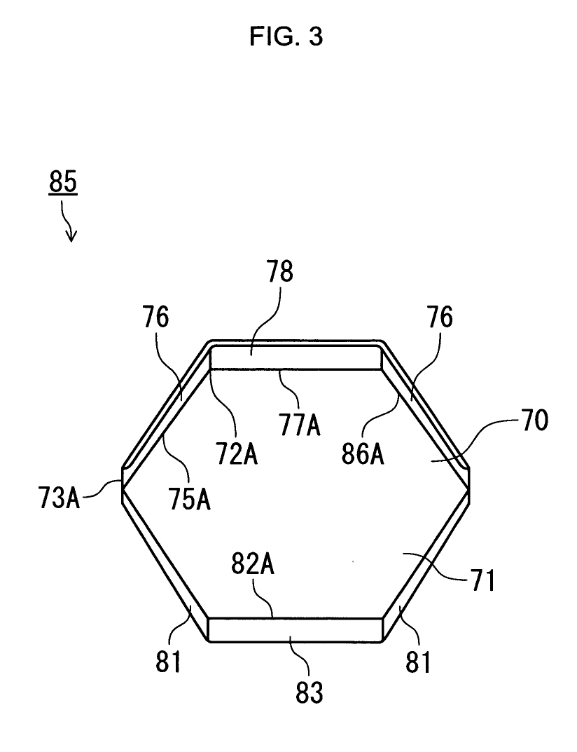

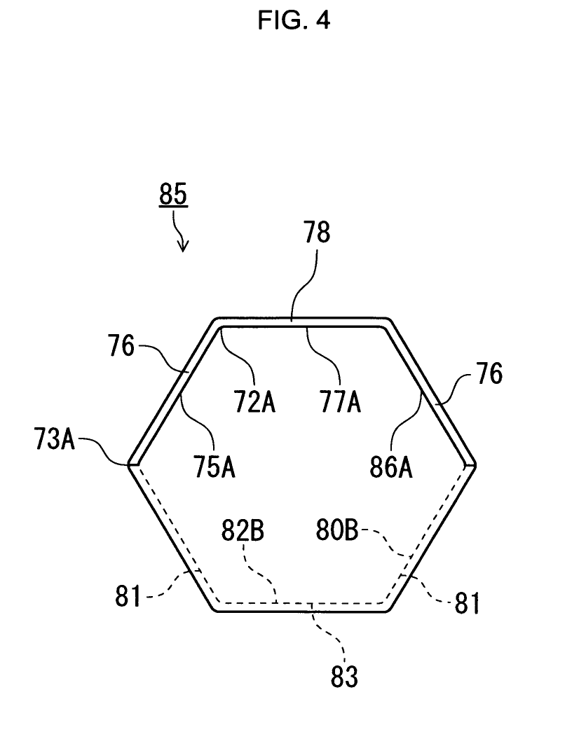

Next, a second embodiment of the present invention is explained with reference to FIG. 3 and FIG. 4.

Configuration elements that are to the same as the first embodiment will be assigned identical symbols and their explanation will be omitted.

The differences between the second embodiment and the first embodiment are the followings: in a cutting board 85 of this embodiment, a first plane 71 and a second plane (not shown in the figures) of a main body 70 are hexagonal in shape; a first wall 76 is provided at a first side 75A, the first side 75A connecting a first vertex 72A to an adjacent second vertex 73A on the first plane 71 of the main body 70; a second wall 78 is provided at a second side 77A, the second side 77 extending from the first vertex 72A in a direction which is different from the second vertex 73A; a third wall 81 is provided at a third side 80B on the second plane which becomes the back of the first plane 71, the third side 80B connecting a third vertex (not shown in the figures) that is farthest from a first vertex (not shown in the figures) to a fourth vertex (not shown in the figures) that is farthest from a second vertex (not shown in the figures); and a fourth wall 83 is provided at the fourth side 82B on the second plane, the fourth side 82B extending from the third vertex in a direction which is different from the fourth vertex.

In this case, a projection height of the first wall 76 is provided such that it gradually decreases from the first vertex 72A side towards the second vertex 73A side. A projection height of the second wall 78 is made approximately the same as the projection height of the first wall 76 at the first vertex 72A side, and made approximately constant. Thereupon, the projection heights of the first wall 76 and the second wall 78 are adjusted such that at least part of an apex of the first wall 76, an apex of the second wall 78 and the fourth side 82B are on the same plane.

The third wall 81 is formed in the same way as the first wall 76. That is, it is formed such that the projection height gradually decreases from the third vertex towards the fourth vertex on the second plane. A projection height of the fourth wall 83 is made approximately the same as the projection height of the third wall 81 at the third vertex side, and made approximately constant. Thereupon, the projection heights of the third wall 81 and the fourth wall 83 are adjusted such that at least part of an apex of the third wall 81, an apex of the fourth wall 83 and the second side on the second plane (not shown in drawing) are on the same plane. At a fifth side 86A on the first plane 71, the first wall 76 is provided such that the second wall 78 side is of maximum projection height. On the other hand, on the second plane, the third wall 81 is disposed adjacent to the other end of the fourth wall 83 such that the fourth wall 83 side is of maximum height.

This cutting board 85 also can be placed on a horizontal plane such that, during food preparation, the first plane 71 side becomes the front side. During this, the main body 70 is disposed in an inclined position supported by the second side on the second plane, the third wall 81 and the fourth wall 83, such that the fourth vertex 82A side on the first plane 71 is at the highest point from the horizontal plane and the second vertex 77A side is at the lowest point. During this, the prepared food material or liquid state material on the first plane 71 moves by gravity from the fourth side 82A side towards the second side 77A side. Thereupon, by encountering the second wall 78, the movement is controlled. During this, since the first wall 76 and the second wall 78 are connected at the first vertex 72A, the food material or the liquid state material is held back, thereby preventing the flow off from the first plane 71.

When the front and rear sides are changed so that the second plane side becomes the preparing surface of the front side, the main body 70 is disposed in an inclined position supported by the fourth wall 82A on the first plane 71, the first wall 76 and the second wall 78. After preparation of foods, it can be made self-standing and stored by setting the first wall 76, the second wall 78, third wall 81, or the fourth wall 83 as bottom.

According to this cutting board 85, in the same way as the case where the first plane and the second plane are quadrangular shape, the main body 70 can be disposed in an inclined position in a given direction, and the direction of scatter, rolling or flow of the food material on the preparing surface can be maneuvered in the same direction. Thereupon, the outflow can be held back by first wall 76 and the second wall 78, or the third wall 81 and the fourth wall 83. On the other hand, when transferring these food materials out of the cutting board 85, it will be possible to easily transfer from a spot where the first wall 76 and the second wall 78, or the third wall 81 and the fourth wall 83 are absent.

Incidentally, the technical scope of the present invention is not limited to the embodiments described above, and various modifications can be practiced without departing from the spirit of the invention. For example, the shapes of the first plane and second plane of the main body are not limited to quadrangular or hexagonal shape, and a polygonal shape not less than quadrangular shape is possible. Further, it is obvious to those skilled in the art that various changes or modifications can be contemplated in the categories mentioned in the claims, and it should be understood that they also are included within the technical scope of the present invention.

What is claimed is:

1. A cutting board comprising:
a main body provided with a first plane and a second plane of N-gon shape (N is an integer not less than 4), the first plane and the second plane being mutually disposed at front and back, the main body comprising:
a first wall projecting towards the first plane side from at least a part of a first side connecting a first vertex and a second vertex disposed adjacently of the main body;
a second wall projecting towards the first plane side from at least a part of a second side extending from the first vertex in a direction which is different from the second vertex;
a third wall projecting towards the second plane side from at least a part of a third side, the third side connecting a third vertex that is farthest from the first vertex to a fourth vertex that is farthest from the second vertex; and
a fourth wall projecting towards the second plane side from at least a part of a fourth side extending from the third vertex in a direction which is different from the fourth vertex, wherein,
a projection height of the first wall is reduced from the first vertex side towards the second vertex side,
a projection height of the second wall at the first vertex side is approximately identical to the projection height of the first wall at the first vertex side, and is maximized,
a projection height of the third wall is reduced from the third vertex side towards the fourth vertex side, and
a projection height of the fourth wall at the third vertex side is approximately identical to the projection height of the third wall at the third vertex side, and is maximized.

2. The cutting board according to claim 1, wherein
the first plane and the second plane are of rectangular shapes,
the projection height of the second wall gradually decreases in a proportion substantially the same as that of the first wall, and
the projection height of the fourth wall gradually decreases in a proportion substantially the same as that of the third wall.

3. The cutting board according to claim 2, wherein the first plane and the second plane have not less than 5 sides,
the projection height of the second wall is approximately the same as a maximum projection height of the first wall, and is approximately constant, or
the projection height of the fourth wall is approximately the same as a maximum projection height of the third wall and is approximately constant.

4. The cutting board according to any one of the claims 1 to 3, wherein
the first wall and the second wall are joined at the first vertex, and
the third wall and the fourth wall are joined at the third vertex.
